(19) United States
(12) Patent Application Publication
(10) Pub. No.: US 2026/0187124 A1
(43) Pub. Date: Jul. 2, 2026

(54) AI-Based Dialog Management with Autonomous API Integration and Real-time Personal Data Synchronization

(71) Applicant: Sestek Ses ve Iletisim Bilgisayar Teknolojileri San. ve Tic. A.S., Istanbul (TR)

(72) Inventors: Levent Arslan, Istanbul (TR); Mustafa Erden, Istanbul (TR); Cagatay Yurdasal, Istanbul (TR); Mert Cikan, Istanbul (TR)

(73) Assignee: Sestek Ses ve Iletisim Bilgisayar Teknolojileri San. ve Tic. A.S., Istanbul (TR)

(21) Appl. No.: 19/004,481

(22) Filed: Dec. 30, 2024

(51) Int. Cl. G06F 16/334; G06F 9/54; G06F 16/335

(52) U.S. Cl. CPC G06F 16/3347; G06F 9/54; G06F 16/337

(57) ABSTRACT

A computer-implemented method dynamically routes and processes user queries in a bot-builder system. The method involves receiving a user query and routing the user query to a Personal Info Retrieval Module, a Document Retrieval Module, and a Tool Manager. The Personal Info Retrieval Module retrieves and updates personal information in real time through API calls. The Document Retrieval Module and Tool Manager retrieve document and tool embeddings from corresponding vector stores. An AI model processes the user query to generate query embeddings, performing similarity searches against the document and tool embeddings. The retrieved information is combined with the user query and chat history to form a comprehensive input, which the AI model processes to determine an appropriate response. The response is generated using existing knowledge or by invoking an external tool. The system includes real-time updates, leveraging historical interaction records and external services and integration of external tools.

### FIELD OF THE INVENTION

The present invention relates to artificial intelligence and natural language processing technologies, specifically to systems for managing and creating conversational agents with integrated personal information retrieval, document retrieval, and tool management capabilities.

### BACKGROUND

Current user data management systems face significant inefficiencies, complexities, and vulnerabilities. These systems often rely on multiple APIs (Application Programming Interface) to retrieve information from various independently structured data providers. This approach results in increased latency, integration challenges, and data inconsistencies. The need for multiple API calls to access user-related information complicates the data management process and can lead to fragmented and unreliable data. Existing solutions also struggle with real-time updates and synchronization of user information across different systems. The lack of a unified source of truth for user data exacerbates these issues, making data accuracy and consistency difficult to maintain. Additionally, the reliance on external APIs introduces security risks and increases the potential for unauthorized access to user information. The current approach to user data management does not adequately address these challenges, highlighting the need for a more streamlined and secure solution.

As AI continues to evolve, applications are becoming increasingly complex and sophisticated, driving a significant demand for human expertise and effort to design, manage, and optimize these advanced systems effectively. Previously, creating a chatbot involved simply adding conversational history to the language model. However, modern chatbots and retrieval-augmented generation (RAG) applications are far more intricate, particularly when they require retrieving information from web, local data sources and functions. These applications have become significantly more agent driven. However, with these intricate workflows, especially when an agent might make numerous API calls, the complexity of setting up and maintaining the system has also increased. In the current landscape of user data management and interaction, the predominant approach involves the utilization of multiple APIs to interact with various independently structured data providers. This method requires separate API calls to different systems for each piece of user information, such as birth dates, transaction histories, and conversation history with contact center bots. While effective to a certain extent, this approach presents significant drawbacks, particularly in terms of efficiency, consistency, and reliability. Making multiple API calls for every user interaction increases the time and computational resources needed to process requests. Each call adds latency, which can significantly impact the system's performance, especially in high-traffic environments. Developers must invest considerable effort in integrating and maintaining connections with each individual API, leading to longer development times and higher costs.

Previous methods for incorporating data into AI-driven systems often relied on embedding information directly into the prompt itself. This approach aimed at providing the AI model with the necessary context to generate relevant and accurate responses. However, embedding data within the prompt introduces significant limitations. One primary disadvantage is the increase in prompt size and complexity. As more data is embedded, the prompt can become excessively large, potentially exceeding token limits of the AI model leading to delays, prompt bloating, and difficulty scaling the retrieval process for dynamic prompts. This not only reduces efficiency but may also lead to performance degradation, such as slower response times and reduced processing accuracy. Additionally, managing and updating such complex prompts becomes increasingly cumbersome, especially when dealing with dynamic or frequently changing data. A long prompt requires careful prompt engineering, where the input is structured and organized in a way that allows the model to extract the most relevant details without getting overwhelmed by unnecessary or irrelevant information. Long prompts that aren't well-constructed may confuse the model or cause hallucinations, where the model generates incorrect or nonsensical outputs. As a result, the shortcomings of embedding data directly into prompts create challenges in efficiency, scalability, and usability, highlighting the need for a more advanced system capable of handling dynamic and context-aware interactions without compromising performance.

To address these problems, techniques like prompt engineering, retrieval-augmented systems, and scope limitation are employed to create more focused and contextually relevant prompts. As a result, older methods often attempted to retrieve all available data from APIs, leading to inefficient data handling. While these approaches mitigate the core issues, they also introduce new complexities, including additional processing overhead and the necessity for meticulous data management to ensure accuracy and efficiency. On the other hand currently, many user data management and interaction systems rely on static AI models trained on publicly available data. These systems can pull information either from databases or external services such as CRM systems. However, when tasked with using historical user data dynamically, such as retrieving previous conversations or incomplete tasks, the traditional approaches often struggle with the complexity of real-time retrieval and context generation.

One major limitation of the existing technology is the dependency on the availability and consistency of numerous APIs. Each API may have its own structure, update schedules, and potential for downtime, leading to a fragmented and often unreliable data retrieval process. When these APIs undergo changes—such as updates to their endpoints, authentication mechanisms, or data structures—the systems that rely on them can break, leading to service interruptions and increased maintenance overhead. This fragmentation not only complicates the integration process but also makes it challenging to ensure the accuracy and timeliness of the data retrieved. Furthermore, the existing methods require substantial resources to manage the integration and ongoing maintenance of these APIs. Developers must continuously monitor and adapt to changes in external systems, which diverts attention from core functionalities and innovation. This scenario becomes particularly problematic in dynamic environments where user data is frequently updated, as each change necessitates a corresponding update in the integration logic.

The shortcomings of existing technologies, particularly AI models Open AI models, in managing a growing number of functions result in a significant inability to determine whether answers should be based on tool usage or retrieved knowledge, as well as to reliably identify the correct function afterward. These limitations underscore the need for a more robust, scalable, and intelligent mechanism to handle function calling, classify intents, and streamline the process for systems operating at scale.

Traditional methods also create substantial overhead in maintaining data synchronization and consistency. When user information is distributed across different systems, ensuring that all data points are up-to-date and synchronized becomes a daunting task. This often leads to stale or inconsistent data, negatively impacting user interactions and overall system performance. In the context of personalized interactions, such as those facilitated by chatbots or AI-driven interfaces, the current approach falls short in delivering a seamless and coherent user experience. Fetching data from multiple sources not only introduces latency but also complicates the logic required to aggregate and interpret the data effectively. This can result in fragmented and unsatisfactory user interactions, undermining the AI system's effectiveness.

Previous methods for integrating APIs and managing data retrieval relied heavily on predefining integration logic for each API. This approach assumes that the API endpoints and their usage requirements are predictable and can be prepared in advance. However, this is rarely feasible in dynamic systems where the exact API to be used, or the specific data needed, cannot always be determined ahead of time. This limitation makes it impractical to create static, predefined integrations for all potential scenarios.

In current standards, functions are not typically stored within an embedding pool to be selected based on embedding similarity. Instead, systems often rely on explicit descriptions of the function. For instance, a system may require a well-defined description, such as “get weather,” to identify the intended functionality. Additionally, the invocation of such a function depends on predefined requirements explicitly outlined, such as specifying the necessary inputs or conditions for proper execution. This approach is less dynamic and relies heavily on precise descriptions rather than contextual or similarity-based matching.

These shortcomings highlight the inefficiencies of traditional methods since they cannot dynamically update personal information and knowledge base information together with API when needed. This creates a pressing need for innovative approaches that address these limitations, enabling more streamlined and responsive API usage.

To address these challenges, this invention proposes a novel approach that consolidates all user-related information into a single, self-contained document—whether in JSON (JavaScript Object Notation) format, a database, or another structured form. This consolidation eliminates the need for multiple external APIs, simplifying data management and enhancing system resilience against changes in external data providers. By maintaining all user information in a unified format, the system can ensure data consistency, improve retrieval efficiency, and reduce latency. This approach also minimizes security vulnerabilities by reducing the number of external calls and simplifies the maintenance and scalability of the system.

Traditional bot-builder systems face several challenges in efficiently and accurately processing user queries. These challenges include:

Static Data Embedding: Existing systems often embed data directly into prompts, leading to increased size and complexity, which can degrade model performance and efficiency.

Manual API Integration: The process of manually listing and defining individual APIs and their functions is time-consuming and prone to errors.

Inefficient Function Selection: Traditional methods struggle to accurately and efficiently identify the appropriate function to call from a vast set of available options, often involving complex logic or trial-and-error approaches.

Lack of Real-Time Updates: Static embedding methods risk becoming outdated, as they do not continuously update personal information and embeddings in real time.

Inadequate Personalization: Existing systems often fail to leverage user-specific data, historical interaction records, and real-time updates to deliver highly personalized and contextually relevant responses.

Complexity in Handling Diverse Queries: Traditional systems struggle with managing dynamic prompts and integrating various data sources, such as personal information, document chunks, and tool results, based on the query context.

### SUMMARY

The invention presents a computer-implemented method for dynamically routing and processing user queries in a bot-builder system, addressing the aforementioned challenges through the following innovative features:

Dynamic Routing and Processing: The method involves receiving a user query at a bot-builder service and routing it to a Personal Info Retrieval Module, a Document Retrieval Module, and a Tool Manager. This multi-layered approach ensures comprehensive query resolution.

Real-Time Personal Info Retrieval: The Personal Info Retrieval Module retrieves personal data from external services (e.g., CRM platforms, HR systems) via API calls and updates the Personal Info Store in real time, ensuring up-to-date information.

Efficient Document and Tool Embeddings: Document and tool embeddings are generated by transforming textual data, tool descriptions, metadata, or usage examples into high-dimensional vectors, enabling fast and accurate similarity searches.

Similarity Search for Relevant Data: The method performs similarity searches using query embeddings against document and tool embeddings in a vector store to retrieve the most relevant document chunks and tools. Text embeddings convert the text to a numerical representation. During this conversion the models learn to preserve the meaning of text. When similar sentences and documents are converted to embeddings, they are close to each other. When semantically different texts are converted to embeddings, they are far away from each other. The distance between numerical vector representations can be measured by different metrics, one of them is cosine distance.

Comprehensive Input Processing: The retrieved personal information, document chunks, and tools are combined with the user query and chat history to form a comprehensive input, which is processed by an AI model to determine an appropriate response pathway.

Seamless API Integration: The Tool Manager transmits API Documentation of external services to an AI model, which converts the specifications into a Tool Use format. This format is embedded into the vector store, enabling seamless and efficient function handling.

Real-Time Embedding Updates: The embeddings in the vector store are dynamically updated in real time, ensuring that responses reflect the most current data. There are other applications for vector stores. It is like a normal database but specialized for vector storing and vector search. Also, the application needs hardware containing persistent storage. Personalized and Context-Aware Responses: The AI model integrates retrieved data, tools, and user context to deliver accurate, personalized responses. Historical interaction records and additional external services such as CRM data are leveraged to generate more context-aware responses.

Automated Tool Calling: If an external tool is required, the AI model generates the necessary API call, which is executed through the Tool Manager. The results from the external tool are integrated back into the system for further processing by the AI model, ensuring seamless integration and execution.

By addressing the limitations of traditional systems, this invention provides a robust solution for efficient, automated processes in various domains, delivering highly personalized and contextually relevant responses with minimal input.

The present invention relates to a computer-implemented method for dynamically routing and processing user queries in a bot-builder system. The method involves receiving a user query at a bot-builder service and routing it to a Personal Info Retrieval Module, a Document Retrieval Module, and a Tool Manager. The Personal Info Retrieval Module retrieves personal information from a Personal Info Store, updating it in real time through API calls to external services. The Document Retrieval Module retrieves document embeddings from a vector store, generated by transforming textual data into high-dimensional vectors. Similarly, the Tool Manager retrieves tool embeddings from the vector store, generated by transforming tool descriptions, metadata, or usage examples into high-dimensional vectors.

The user query is processed by an AI model to generate query embeddings, which are then used to perform similarity searches against the document and tool embeddings in the vector store. The most relevant document chunks and tools are retrieved and combined with the personal information, user query, and chat history to form a comprehensive input. This input is processed by the AI model to determine an appropriate response pathway.

The response is generated based on the comprehensive input, either using existing knowledge and personal information or by invoking an external tool. If an external tool is required, the necessary API code is generated through Tool Manager and API call executed through Bot Builder. The results from the external tool are integrated back into the system for further processing by the AI model, and the final response is delivered to the user.

The method also includes features such as real-time updates to the Personal Info Store, leveraging historical interaction records and CRM data for personalized responses, and seamless integration of external tools through API Documentation such as OpenAPI JSON specifications. The AI model generates client code for tool or API calls, ensuring efficient and accurate function handling. The system continuously updates embeddings in the vector store to reflect the most current data, providing accurate and contextually relevant responses.

### Advantages

1. Consolidation of user-related information into a single document, formatted as a JSON file.
2. Real-time updates and synchronization of user information across systems.
3. Use of AI-powered response-generation mechanisms for personalized responses.
4. Retrieval-Augmented Generation (RAG) system for contextually relevant responses.
5. Enhanced data security and reduced latency by eliminating multiple API calls.
6. Improved data analytics and machine learning through a unified data structure.
7. Scalability and centralized updates to accommodate growing user data.
8. Faster implementation on a computer/computers as a result of parallel processing. The system is implemented on a computer platform, and bot-builder 10 routes the received query 16 to the Document Retrieval Module 13, Personal Info Store 20, and Tool Manager 11, this parallel processing improves the speed of the system and the computer platform used can have an improved efficiency.

This method supports more sophisticated and personalized interactions by providing a richer and more consistent data set for AI models, ultimately improving the overall user experience.

### Term Definitions

An Application Programming Interface (API) is a set of rules and protocols that allows different applications to communicate with each other. It defines the methods and data structures that developers can use to interact with the functionalities provided by an algorithm component, service, or system, enabling integration and interaction between disparate systems.

JSON (JavaScript Object Notation) is a lightweight data interchange format that is easy for humans to read and write, and easy for machines to parse and generate. It is based on a subset of the JavaScript programming language and is commonly used for transmitting data in web applications between a server and a client. JSON structures data in a key-value pair format, making it a versatile and widely adopted standard for data representation.

RAG (Retrieval-Augmented Generation) is a technique that combines the capabilities of retrieval-based systems and generative models to produce more accurate and contextually relevant responses. In a RAG system, when a query is received, the model first retrieves relevant information from a large database or knowledge base. This retrieved information is then used by a generative model to construct a response that is both informed by the retrieved data and tailored to the specific context of the query. This approach leverages the strengths of both retrieval and generation, enabling the creation of sophisticated and personalized interactions.

OpenAPI, also known as the OpenAPI Specification (OAS), is a standard framework for defining and describing RESTful APIs in a machine-readable format. It allows developers to specify the endpoints, request and response formats, authentication methods, and other aspects of an API in a structured way, typically using JSON or YAML. The primary purpose of OpenAPI is to facilitate the creation, documentation, and consumption of APIs by providing a clear and consistent specification that can be used to generate client libraries, server stubs, and API documentation automatically. This standardization helps ensure that APIs are well-documented, easy to understand, and interoperable across different systems and platforms.

Artificial Intelligence (AI) refers to the simulation of human intelligence in machines that are programmed to think and learn like humans. AI encompasses a wide range of technologies and methodologies, including machine learning, natural language processing, computer vision, robotics, and expert systems. The primary goal of AI is to create systems that can perform tasks that typically require human intelligence, such as recognizing speech, making decisions, solving problems, and understanding natural language. AI systems can be classified into two main types: narrow AI, which is designed for specific tasks, and general AI, which aims to perform any intellectual task that a human can do. AI technologies are widely used in various applications, including virtual assistants, autonomous vehicles, recommendation systems, and healthcare diagnostics.

### BRIEF DESCRIPTION OF THE DRAWINGS

FIG. 1 shows how Bot-builder Service is connected to Personal Infor Retrieval module, Document Retrieval module and Tools module and AI model

FIG. 2 shows the details of Personal Info Retrieval Module

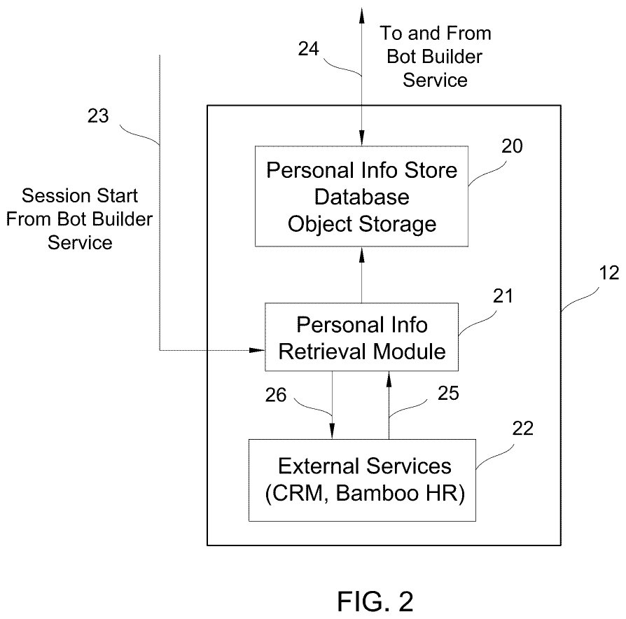

FIG. 3 shows the details of the Document Retrieval Module

FIG. 4 shows the details of Tools Module

FIG. 5 shows the algorithm used to respond to a user query

FIG. 6 shows the algorithm used by the system to respond to a user query

FIG. 7 shows implementation of the algorithm using computers

FIG. 8 shows Implementation of the algorithm using multiple processors and storage and random access memories.

### DETAILED DESCRIPTION

### Definitions for Architecture

User Query: 16. This is the initial request or question submitted by the user to the Bot-builder service as the starting point for the interaction designed to retrieve specific information.

Bot-builder Service: 10. This entity orchestrates user queries by integrating components like natural language understanding, Speech Recognition, AI and Text-to-Speech, enabling seamless interaction in conversational AI systems. Also, it invokes the API call immediately after the AI Model identifies the need to use external tools to obtain the necessary information or execute specific tasks. Bot Builder Service is some kind of orchestrator. It manages different components. It calls the necessary components, gets the answer and passes the answer to other related components. Also, it is responsible for designing the dialogue flows. Which means the users of the system determine the main steps of achieving a predefined goal. This is done through designing flow diagrams including different components such as AI models, vector stores, tools and model configurations.

Personal Info Store: 20. This entity is a flexible and scalable repository designed to securely store personal information associated with individual users. It stores user-specific data, supporting both structured databases (e.g., SQL, NoSQL) and unstructured object storage systems (e.g., MinIO, S3), Json.

Personal Info Retrieval Module: 12. Managing and updating the Personal Info Store by interfacing with external services, such as CRMs, through APIs. It ensures that the stored data remains accurate, up-to-date, and reflects the latest information from these external systems.

Personal Info Retrieval: 21. This is the process of retrieval of personal information from personal info storage.

AI Embedding Model: 30. The AI Embedding Model is an entity designed to extract embeddings, which are numerical representations of words or phrases derived from the input query. These embeddings capture the semantic meaning of the query in a format suitable for storage and retrieval in a vector store. There are models that take the text as input and the output is generally a fixed dimension vector. Meaning a list of float values with a specific count such as 768. Of course, the values are not random. The model is trained to preserve the semantical meaning of text. It means for similar sentences/documents/functions the generated embeddings are close to each other.

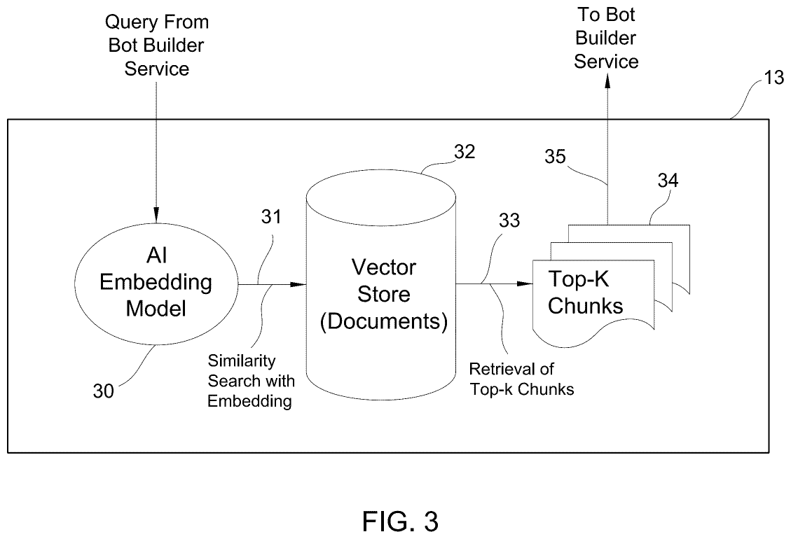

FIG. 3 shows the document retrieval module 13 and its elements as below.

Document Retrieval Module: 13. This process is responsible for conducting a similarity search using embeddings generated by AI embedding model within the Vector Store (Document) to retrieve the most relevant document chunks related to the user's query.

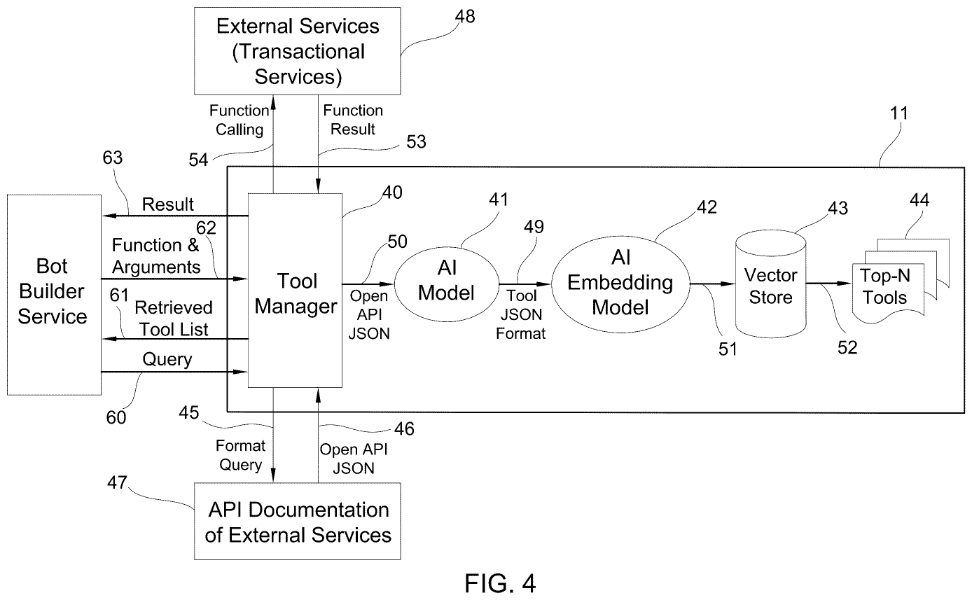

FIG. 4 shows the Tool Manager: 40. This entity is responsible for two fundamental tasks:
1) Defining tools in the format expected by the AI model by utilizing API documentation (E.g., Swagger) where the name, description, and arguments are specified in the AI tool use format.
2) Crafting API-calling code, leveraging API documentation module like Swagger to define and generate precise API specifications.

Vector Store (Tools): 43. Efficiently stores numerical representations of tools in a compact and optimized format. Supports rapid querying to identify the most similar vectors to a target vector based on similarity metrics.

Vector Store (Documents): 32. Efficiently stores numerical representations of documents in a compact and optimized format. Supports rapid querying to identify the most similar vectors to a target vector based on similarity metrics.

API Documentation: 47. This entity functions as a foundational component (e.g., Swagger) of the Tool Manager system, translating complex API specifications into automated workflows. The module organizes API documentation into a tool list, which can be prepared for interpretation by AI models.

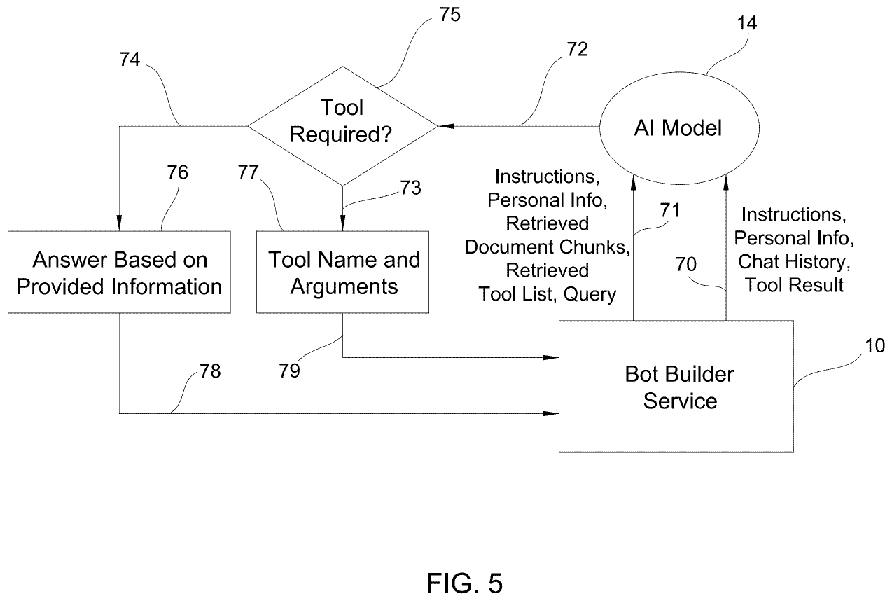

FIG. 5 shows AI Model 14. This entity acts as the central processing component that receives and integrates the information retrieved from System Prompt (instruction), Personal Info, Chat History, and Tool Result (retrieved function names). AI decides whether tool usage is required or not based on the information provided. The AI Model either generates a direct response to the user based on the available information or determines that a tool needs to be utilized to fulfill the query. In cases where sufficient information is already in hand, it provides an immediate, accurate answer based on personal info only, personal info+document retrieval. Alternatively, if the query requires additional processing or external data retrieval, the model intelligently identifies the need for tool usage with a defined tool name and initiates the necessary actions to complete the task. In this case personal info+document retrieval+tool retrieval is adopted. If a tool needs to be invoked, the AI Model ensures that the necessary tool arguments are properly identified and filled to facilitate the tool usage process.

The starting point of the presented invention is the query 16 transmission from a user 15 to a bot-builder entity 10. Interaction is initiated between a user 15 and a system designed to manage or create conversational agents (bots).

As a session start event the bot-builder service 10 routes the received query 16 to initiate the “Personal Info Retrieval Component” to retrieve the personal information.

Personal Info Retrieval Module 12 (such as database (sql, no-sql (MongoDB)), object storage (minio, s3))., is updated through alternative methods.

In one implementation the Personal Info Retrieval Module 12 invokes personal data through an API call 26 to external services 22 and seamlessly updates the personal information store 20 with the acquired data. This action is essential to fetch personal information from external services 22 (e.g., CRM platforms or BambooHR etc.).

In an alternative implementation, external services may directly update the Personal Info Store 20 if there is a change/update in personal information.

Subsequently, personal information is seamlessly retrieved from the Personal Info Store 20, ensuring efficient access to up-to-date and relevant data.

In parallel the bot-builder service 10 routes the received query 16 to the Document Retrieval Module 13 and Tool Manager 11. As the system is implemented on a computer platform, and bot-builder 10 routes the received query 16 to the Document Retrieval Module 13, Personal Info Store 20, and Tool Manager 11, this parallel processing improves the speed of the system and the computer platform used can have an improved efficiency. Parallel processing can either be implemented in a single computer or a computer with the capability of parallel processing.

Before retrieving documents and tools, the data (documents and tools) must be prepared for embedding. The data undergoes embedding process which transforms the textual data into numerical representations known as embeddings. These embeddings encapsulate the semantic meaning of the text, converting it into a high-dimensional vector space. The generated embeddings are stored in a vector store 43 alongside their relevant content. This specialized database allows for efficient storage and retrieval of high-dimensional vectors, enabling fast and accurate search capabilities. In dynamic processes, this phase is executed iteratively at each step before retrieval, adjusting in real-time to changing requirements. Otherwise, embeddings may not be generated repeatedly, reducing computational overhead.

Document indexing is conducted by dividing original text documents into smaller, manageable chunks. These chunks are then transformed into embeddings, which enable fast and accurate search capabilities within the vector store.

Tool indexing is conducted by transforming tool descriptions, metadata, or usage examples into embeddings that align with the same vector space 32 as document embeddings.

The query submitted by users 15 and routed through the bot-builder service 10, is also processed by the embedding model 30.

During the inference phase, the system utilizes embeddings to process queries 16, 19 and retrieve the most relevant results. This phase involves two key sub-processes:

The input query embeddings are compared against document embeddings in the document vector store 32. A similarity search is performed to retrieve the most relevant document chunks, with the vector store identifying the top-K chunks 34 that best align with the query embedding. Retrieved document information 35 is then fed to the prompt.

The input query embeddings are compared against tool embeddings stored in the vector store 43. A similarity search is performed to retrieve the most relevant tools. By leveraging the query embeddings 51, the Tool Manager 40, retrieves the Top-N tools 44 from the tool vector store 43 based on their alignment with the query 60. Based on similarity scores, the most suitable tools 61 for the task are retrieved. These tools are then injected into the prompt to ensure an effective and comprehensive resolution of the query.

### Autonomous External API Integration

FIG. 4 shows the tool manager 11. Instead of manually listing and defining individual APIs, and providing specific functions one by one, the Tool Manager 40 transmits the OpenAPI JSON 46 specifications directly from API Documentation Module 47 and passes them to an AI Model 41.

The AI Model 41 processes this input and converts it into a Tool Use JSON format 49, streamlining the process of defining and utilizing tools without the need for manual intervention. AI Model 41 is currently a large language model such as OpenAI's GPT models.

Subsequently, this “tool use” JSON format 49 is embedded into a vector store 43, enabling seamless and efficient function handling.

The AI model 41 generates the client code required to call the selected tool/API, enabling seamless integration and execution.

FIG. 5 shows the interaction between the bot-builder service 10 and the AI Model 14. The bot-builder 10 sends a combination of the following elements to an AI-based model 14: the prompt, personal information, retrieved document chunks combined with user's original query and chat history, a list of available top-N tools 70, 71.

The AI Model 14 processes this data to determine the appropriate response pathway. In one possible scenario, the AI-based model processes the input data and generates a response solely based on the information already available in knowledge base and personal information 76, without the need for external tool usage 77. In such cases, the system autonomously formulates the response and directly transmits it to the end user. The AI Model 14 structure and function is similar to the AI Model 41.

Alternatively, if the AI model determines that additional processing or data from external tools is necessary, it will output a notification indicating that “tool usage is required.” The model will decide to specify which external tool should be invoked 77. While the AI model 14 identifies the required API call, it cannot execute it; the bot-builder 10 will handle the execution and return the response. The system then utilizes the tool manager 40 to orchestrate the interaction with the appropriate external service 47, such as CRM, Bamboo, or other third-party systems, to perform the required function. Upon execution, the results from the tool are collected and integrated back into the system for further processing. After the tool is utilized, the results, along with the instructions, personal information, chat history, and tool results, are sent back to the AI-based model 14. The model 14 processes these inputs to generate a final response, which is then delivered to the end user.

This invention presents a revolutionary system that streamlines and reduces human effort by seamlessly combining AI capabilities with a bot-builder service. The system offers a flexible framework designed to handle diverse user needs through the integration of personal information management, document retrieval, and function retrieval and function calling. Additionally, it leverages Augmented Generation (RAG) technology, enabling the system to combine real-time data retrieval with advanced generative capabilities, ensuring accurate and contextually relevant responses for a wide range of user queries. At its core, the system employs a modular architecture that harmonizes its components to process queries, retrieve relevant data, and execute external functions via an effortless API-driven approach. This design ensures that the system remains dynamic, scalable, and highly adaptable to a wide range of applications.

By leveraging these features, the system effectively addresses complex tasks with minimal input, providing a robust solution for efficient, automated processes in various domains.

The system is built around a core bot-builder service 10, which manages the entire orchestration process—from receiving and interpreting user queries 16 (intent recognition) to delivering contextually accurate and personalized responses 17. The system wears multiple hats such as Personal Info Retrieval Module 12, Document Retrieval Module 13, and Tool Manager 11, embracing multi-modality to both optimize and personalize the responses and ensure the efficient execution of diverse queries.

The process begins with the user submitting a query through an interface connected to the bot-builder. The bot-builder simultaneously initiates parallel retrieval operations across three key components: personal information from the Personal Info Store 20, knowledge-based information using the RAG framework, and relevant tools or APIs via the Tool Manager 11. Personal data, such as user profiles or historical interactions, is retrieved alongside contextual documents from repositories 21 and external tool or function outputs 22. The results from these parallel retrievals are then combined and fed into the AI model together with the prompt, ensuring that the model receives a comprehensive set of inputs to generate precise, context-aware responses tailored to the user's query. This parallel operation increases the system speed and efficiency.

Additionally, the use of Personal Info Retrieval adds a layer of personalization and efficiency. By dynamically retrieving data like the Customer ID, the system can tailor its responses to the specific needs of the user without requiring manual input. This makes the system more intuitive and user-friendly, capable of adapting to diverse use cases. The text will be stored in a database and consistently retrieved for use, while the content is dynamically updated with a steady stream of incoming information. As the database is refreshed in real time, the AI model will process the latest data to generate personalized responses.

Another crucial component of the system is Document Retrieval Module 13 which embodies similarity search between query embeddings and company's knowledge base. Query embeddings 31 are matched against document chunk embeddings, enabling the retrieval of the most relevant Top-K documents 34. When necessary, document chunks 34 are dynamically converted into numerical representations and indexed to ensure efficient and accurate matching.

The most critical modality of the invention is the Tool Manager 11, which indexes tools for retrieval based on matching queries in a vector store 43. Similar to Document Retrieval, a similarity search is performed, followed by selecting the Top-N tools 44 to be added to a pool. Additionally, the Tool Manager 40 interfaces with the API Documentation Module 47, leveraging an AI model 41 to transform Open API JSON formats 50 into a tool-compatible JSON format 49.

Moreover the system incorporates a API Documentation (E.g., Swagger) 47, an OpenAPI JSON format 50 is used to define API specifications. The Tool Manager 40 interacts with an AI Model 41 to convert the OpenAPI JSON 50 format into a Tool Use JSON format 49, which is more suitable for execution. Subsequently, this Tool Use JSON format 49 can be embedded into a vector store 43. This process ensures an effortless API integration by simplifying and automating the handling of API specifications and usage. This parsed information is converted into executable workflows within systems, automating the integration process and defining precise operational sequences for API utilization. Upon transmitting the query 16, the system dynamically retrieves information from multiple data sources, including but not limited to personal data, knowledge base entries, and predefined functional datasets. These retrieved data elements are intelligently analyzed and integrated to align with the query's context and the system's operational logic.

If the AI model determines that a tool is required to resolve the query 16, the bot-builder forwards the query to the Tool Manager 11. The Tool Manager 11 interacts with the vector store 43, which contains embedded representations of tools defined through's OpenAPI specifications. A similarity search is conducted in the vector store 43, and the most relevant tools are identified and retrieved using a Top-N selection method. The Tool Manager 11 uses this information to generate the appropriate API call 54, passing the required parameters and triggering the specified function to gather the necessary results 53 from external services. These external services are transactional services such as: money transfer, weather API calls, etc. These represent the primary actions of the Tool Manager 11, distinguishing it from the Personal Information Retrieval Module 12.

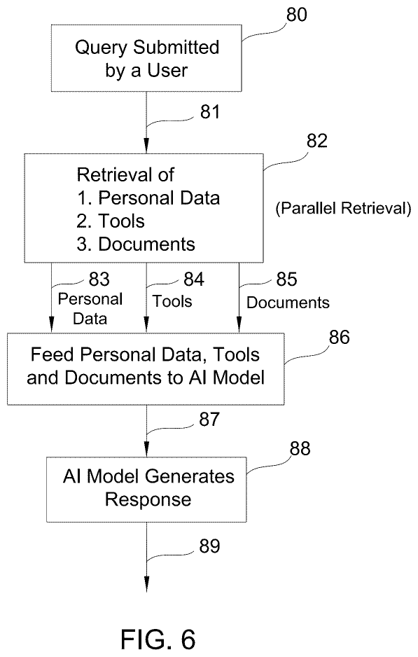

FIG. 6 shows the flow diagram of the algorithm. In step 80, a query 81 is submitted to the system by a user 15. In step 82 bot-builder service 10 retrieves personal data 83, from personal info retrieval module 12, documents 85 from document retrieval module 13, and tools 84 from tool module 11. This operation is done in parallel to speed up the operation of the algorithm. In step 86 the personal data, documents and tools are sent to AI Model 14. In step 88, the AI Model 14 generates response 89 for the inquiry 81 from user 80.

The invention introduces a bot-builder 10 that dynamically routes user queries to various system components, including the Personal Info Retrieval Module 12, Document Retrieval Module 13, and Tool Manager 11, enabling a multi-layered approach to query resolution.

Personal information, document embeddings, and tools are retrieved simultaneously through Retrieval and vector-based similarity searches, ensuring a comprehensive and context-aware response to user queries.

Retrieval-Augmented Generation is employed to generate responses by leveraging the three distinct retrieval phases outlined in the invention.

The system incorporates a Personal Information Manager that retrieves personal data from external services through APIs and updates the Personal Information Store in real time. Additionally, it supports direct updates to the Personal Information Store, enabling streamlined and efficient use cases.

The invention enables the integration of a user's historical conversation data into the personal information or prompt, allowing the system to analyze previous interactions and identify incomplete actions, thereby generating more personalized and context-aware responses.

The system introduces the ability to utilize API Documentation OpenAPI JSON format, converting it into a Tool Use JSON format via an AI Model, enabling seamless and autonomous API integration. By embedding the parsed Tool Use JSON into a vector store, the system dynamically retrieves the Top-N 44 most relevant tools and sends them to the AI model for selection. This innovation eliminates the need for manual tool definitions and enables autonomous, AI-driven dialog management, tool retrieval, and execution based on relevance.

The AI Decision Model determines whether a query can be resolved using existing knowledge or requires external tool invocation. It integrates retrieved data, tools, and user context to deliver accurate, personalized responses.

The system includes logic to manage dynamic prompts, which require multiple entity changes. This logic ensures accuracy and adaptability when interacting with varying entities.

Unlike traditional systems that struggle with historical context, this invention allows the integration of CRM data, including various formats like chat logs and telephonic conversations, into a Retrieval-Augmented Generation (RAG) framework.

By leveraging historical records and additional CRM data, the invention shortens and simplifies the complexity of prompts.

The system addresses the challenge of retrieving specific customer information related to their most recent actions or transactions.

The system introduces a novel separation of roles between the AI model and the bot-builder. The AI model functions as a design engine, generating a code and operational logic required to connect to the correct API endpoint, including determining the necessary parameters and constructing the function call. Meanwhile, the bot-builder acts as an execution layer, utilizing the code or method call provided by the AI model to initiate and manage the process.

By combining user-specific information, historical data, and external resources, the invention delivers highly personalized and context-aware responses, setting it apart from traditional systems.

Unlike prior methods that directly embed data into prompts, increasing their size and complexity, this invention utilizes advanced techniques like Retrieval-Augmented Generation (RAG) and modular data management. This approach reduces prompt size while maintaining rich context, leading to improved model performance and efficiency.

The invention introduces advanced mechanisms for accurately and efficiently identifying the appropriate function to call from a vast set of available options. This mitigates the inefficiencies observed in traditional systems, where selecting the correct function often involves complex logic or trial-and-error approaches. The invention ensures that even in environments with an extensive number of functions, the correct one is quickly and reliably identified.

A key limitation of existing technologies is their inability to reliably differentiate between transactional requests (e.g., performing actions or updates) and non-transactional requests (e.g., retrieving or presenting knowledge-based information). The invention incorporates intelligent intent classification systems that streamline this process, ensuring that each request is correctly categorized and routed. The invention eliminates the limitations of static data embedding by dynamically retrieving and integrating data (e.g., personal information, document chunks, and tool results) based on the query context. This ensures the system always has access to the most relevant and up-to-date information without overloading the prompt.

By introducing a more intelligent and automated approach to function calling and intent classification, the invention reduces the complexity and overhead associated with managing large-scale systems. This leads to fewer resource-intensive manual updates and adjustments, freeing up developers to focus on innovation rather than routine maintenance. On the other hand By leveraging user-specific data, historical interaction records, and real-time updates, the invention delivers highly personalized and contextually relevant responses.

The system continuously updates personal information and embeddings in real time, ensuring that responses reflect the most current data, unlike prior static embedding methods that risk becoming outdated.

Advantages and Improvements Obtained by using the method disclosed in this application:

### Enhanced Query Processing Efficiency

By dynamically routing user queries to the Personal Info Retrieval Module, Document Retrieval Module, and Tool Manager, the system ensures parallel processing and retrieval of relevant data, significantly reducing the time required to generate responses.

### Real-Time Personal Information Retrieval

The Personal Info Retrieval Module updates the Personal Info Store in real time by invoking external services via API calls. This ensures that the system always has access to the most current personal information, leading to more accurate and personalized responses.

### Improved Document and Tool Retrieval

The transformation of textual data and tool descriptions into high-dimensional vectors (embeddings) allows for efficient similarity searches. This enables the system to quickly retrieve the most relevant document chunks and tools, enhancing the relevance and accuracy of the responses.

### Comprehensive Input Formation

Combining retrieved personal information, document chunks, and tools with the user query and chat history forms a comprehensive input for the AI model. This holistic approach ensures that the AI model has all necessary context to generate precise and context-aware responses.

### Adaptive Response Generation

The AI model processes the comprehensive input to determine the appropriate response pathway. This includes generating responses based on existing knowledge and personal information or invoking external tools when necessary, ensuring that the system can handle a wide range of queries effectively.

### Seamless External Tool Integration

When an external tool is required, the system generates the necessary API call and executes it through the Bot Builder. This seamless integration allows for the efficient execution of external functions and the incorporation of their results into the final response.

### Real-Time Embedding Updates

Dynamically updating the embeddings in the vector store in real time ensures that the system's responses reflect the most current data. This continuous update mechanism enhances the accuracy and relevance of the responses.

### Personalized and Context-Aware Responses

By integrating retrieved data, tools, and user context, the AI model delivers highly personalized and context-aware responses. This leads to a more intuitive and user-friendly interaction experience.

### Leveraging Historical Interaction Records

The system leverages historical interaction records and additional external services such as CRM data to generate more personalized and context-aware responses. This historical context allows the system to better understand user needs and provide more relevant answers.

### Efficient Orchestration Process

The bot-builder service manages the entire orchestration process, from receiving and interpreting user queries to delivering contextually accurate and personalized responses. This centralized management ensures a streamlined and efficient query processing workflow.

### Automated API Integration

The Tool Manager transmits API documentation of external services to an AI model, which converts them into a Tool Use format. Embedding this format into the vector store enables seamless and efficient function handling, reducing the need for manual intervention.

### Client Code Generation for Tool Execution

The AI model generates the client code required to call the selected tool or API, enabling seamless integration and execution. This automation simplifies the process of invoking external tools and ensures accurate execution. The bot builder is responsible for invoking the end point of API call.

Increasing computer efficiency and speed: As the system is implemented on a computer platform, and bot-builder 10 routes the received query 16 to the Document Retrieval Module 13, Personal Info Store 20, and Tool Manager 11, this parallel processing improves the speed of the system and the computer platform used can have an improved efficiency.

By implementing these technical effects, the invention significantly enhances the efficiency, accuracy, and personalization of query processing in a bot-builder system, providing a robust solution for handling diverse user needs.

### Embodiment 1

A computer-implemented method for dynamically routing and processing user queries in a bot-builder system, the method comprising:

A computer-implemented method for dynamically routing and processing user queries in a bot-builder system, the method comprising: receiving a user query at a bot-builder service; routing the user query to a Personal Info Retrieval Module, a Document Retrieval Module, and a Tool Manager; retrieving personal information from a Personal Info Store through the Personal Info Retrieval Module, wherein the Personal Info Retrieval Module updates the Personal Info Store in real time by invoking external services via API calls; retrieving document embeddings from a vector store through the Document Retrieval Module; retrieving tool embeddings from the vector store through the Tool Manager; processing the user query by an AI model to generate query embeddings; performing a similarity search using the query embeddings against the document embeddings in the vector store to retrieve the most relevant document chunks; performing a similarity search using the query embeddings against the tool embeddings in the vector store to retrieve the most relevant tools; combining the retrieved personal information, document chunks, and tools with the user query and chat history to form a comprehensive input; processing the comprehensive input by the AI model to determine an appropriate response pathway; generating a response based on the comprehensive input, delivering the final response to the user.

### Embodiment 2

A computer-implemented method for dynamically routing and processing user queries in a bot-builder system, the method comprising: receiving a user query at a bot-builder service; routing the user query to a Personal Info Retrieval Module, a Document Retrieval Module, and a Tool Manager; retrieving personal information from a Personal Info Store through the Personal Info Retrieval Module, wherein the Personal Info Retrieval Module updates the Personal Info Store in real time by invoking external services via API calls; retrieving document embeddings from a vector store through the Document Retrieval Module; retrieving tool embeddings from the vector store through the Tool Manager; processing the user query by an AI model to generate query embeddings; performing a similarity search using the query embeddings against the document embeddings in the vector store to retrieve the most relevant document chunks; performing a similarity search using the query embeddings against the tool embeddings in the vector store to retrieve the most relevant tools; combining the retrieved personal information, document chunks, and tools with the user query and chat history to form a comprehensive input; processing the comprehensive input by the AI model to determine an appropriate response pathway; generating a response based on the comprehensive input, delivering the final response to the user. The Personal Info Retrieval Module updates a Personal Info Store in real time by invoking external services via API calls.

### Embodiment 3

The method as described in embodiment 1 and 2, in addition, the document embeddings are generated by transforming textual data into high-dimensional vectors.

### Embodiment 4

The method as described in embodiment 1, in addition, the document embeddings are generated by transforming textual data into high-dimensional vectors.

### Embodiment 5

The method as described in embodiment 1 and 4, wherein the response is either formulated using existing knowledge and personal information or involves invoking an external tool; if an external tool is required, crafting the necessary API code through Tool Manager and executing it through the Tool Manager; integrating the results from the external tool back into the system for further processing by the AI model; delivering the final response to the user.

### Embodiment 6

The method as described in embodiment 1, in addition in this embodiment Post-Session Conversation flow is implemented along with “personal info”. The proposed solution involves creating an individualized user document that contains comprehensive information about the user, including personal details such as birth dates, transaction histories, and post session conversation flow, customer preferences, behavioral patterns. The purpose of this embodiment is to ensure that user information is updated in real-time and accurately synchronized across systems. Specifically, at the end of a session or interaction, the system prompts a review process that identifies any changes or additions to the user's personal information. By analyzing the session data and comparing it with existing user profiles, the system identifies updates or modifications. These changes are then seamlessly integrated into the user's JSON profile during the post-session process.)

The method as described in embodiment 1, wherein the response is either formulated using existing knowledge and personal information or involves invoking an external tool; if an external tool is required, generating the necessary API call code through Tool Manager and executing API call through the Bot Builder; integrating the results from the external tool back into the system for further processing by the AI model.

### Embodiment 7

The method as described in embodiment 1, wherein the Personal Info Manager retrieves personal data from external services selected from the group consisting of CRM platforms and HR systems.

### Embodiment 8

The method as described in embodiment 1, wherein the document embeddings are generated by dividing original text documents into smaller chunks before transforming them into high-dimensional vectors.

### Embodiment 9

The method as described in embodiment 1 and 4, wherein the tool embeddings are generated by transforming tool descriptions, metadata, or usage examples into high-dimensional vectors that align with the same vector space as document embeddings.

### Embodiment 10

The method as described in embodiment 1, wherein the similarity search performed using the query embeddings against the document embeddings retrieves the top-K most relevant document chunks.

### Embodiment 11

The method as described in embodiment 1, wherein the similarity search performed using the query embeddings against the tool embeddings retrieves the top-N most relevant tools.

### Embodiment 12

The method as described in embodiment 1, further comprising updating the Personal Info Store directly by external services when there is a change or update in personal information.

### Embodiment 13

The method as described in embodiment 1, wherein the AI model processes the comprehensive input to determine whether the response can be generated using existing knowledge and personal information or requires invoking an external tool.

### Embodiment 14

The method of embodiment 1, wherein the Tool Manager transmits OpenAPI JSON specifications from an API Documentation Module to an AI model, which converts the specifications into a Tool Use JSON format.

### Embodiment 15

The method of embodiment 9, further comprising embedding the Tool Use JSON format into the vector store to enable seamless and efficient function handling.

### Embodiment 16

The method of embodiment 1, wherein the AI model generates the client code required to call the selected tool or API, enabling seamless integration and execution.

### Embodiment 17

The method of embodiment 1, further comprising dynamically updating the embeddings in the vector store in real time to ensure that responses reflect the most current data.

### Embodiment 18

The method of embodiment 1, wherein the AI model integrates retrieved data, tools, and user context to deliver accurate, personalized responses.

### Embodiment 19

The method of embodiment 1, further comprising leveraging historical interaction records and additional external services such as CRM data to generate more personalized and context-aware responses.

### Embodiment 20

The method of embodiment 1, wherein the bot-builder service manages the entire orchestration process from receiving and interpreting user queries to delivering contextually accurate and personalized responses.

### Embodiment 21

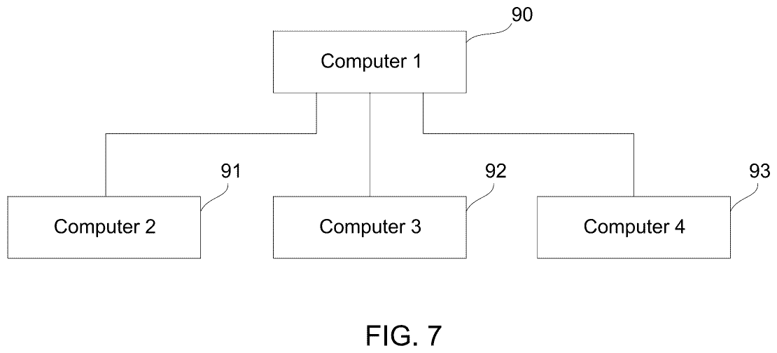

The method of any of the above embodiments, and as shown in FIG. 7 that shows implementation of the algorithm by using computers. The complete system can either be implemented on a single computer such as Computer 90, in which case bot-builder 10, the Document Retrieval Module 13, Personal Info Store 20, and Tool Manager 11, all implemented and executed on computer 90. Since the algorithm performs parallel processing of these modules, the speed and efficiency of the computer 90 is increased in this single computer embodiment. In another embodiment, computer 90, computer 91, computer 92 and computer 93 used in a parallel set up such that bot-builder resides and is executed on computer 90, Document Retrieval Module 13 resides and is executed on computer 91, Personal Info Store 20 resides and is executed on computer 92 and Tool Manager 11 resides and is executed on computer 93. Computer 90, computer 91, computer 92 and computer 93 are connected with each other to accomplish parallel processing. Either embodiment increases the efficiency and speed.

### Embodiment 22

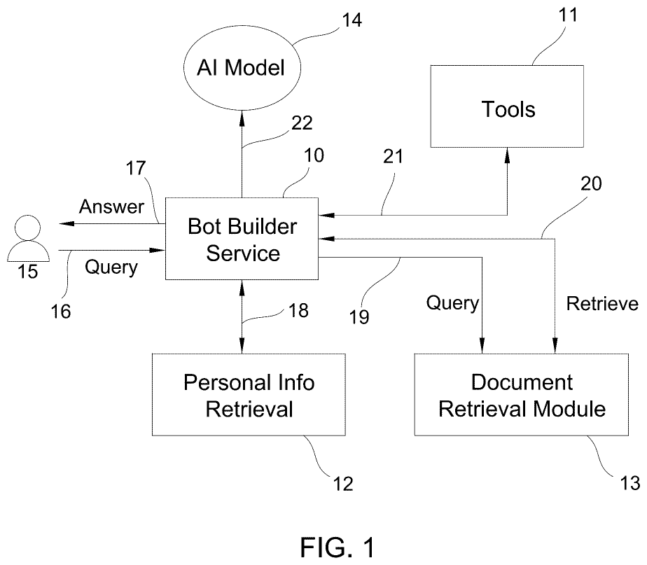

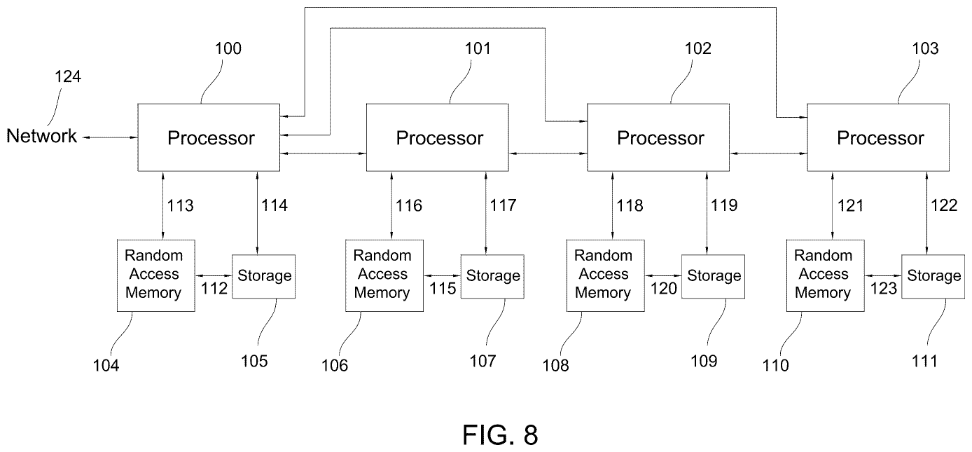

The method of any of the above embodiments, and as shown in FIG. 8 that shows implementation of the algorithm by using a single computer with a plurality of processors, a plurality of random access memories, a plurality of storage and plurality of communication lines. Processor 100, random access memory 104 and storage 105 form a first branch of the parallel processing. Processor 101, random access memory 106 and storage 107 form a second branch of the parallel processing. Processor 102, random access memory 108 and storage 109 form a third branch of the parallel processing. Processor 103, random access memory 110 and storage 111 form a fourth branch of the parallel processing. The system in FIG. 1 is implemented in the first branch of the parallel processing where the algorithm is saved in the storage 105 and moved into random access memory 104 for the execution by the processor. Random access memory 104 is connected to processor 100 by communication lines 113. Storage 105 is connected to processor 100 by communication lines 114. The second branch of the parallel processing where the algorithm is saved in the storage 107 and moved into random access memory 106 for the execution by the processor. Random access memory 106 is connected to processor 101 by communication lines 116. Storage 107 is connected to processor 101 by communication lines 117. The third branch of the parallel processing where the algorithm is saved in the storage 109 and moved into random access memory 108 for the execution by the processor 102. Random access memory 108 is connected to processor 102 by communication lines 118. Storage 109 is connected to processor 102 by communication lines 119. The fourth branch of the parallel processing where the algorithm is saved in the storage 111 and moved into random access memory 110 for the execution by the processor. Random access memory 110 is connected to processor 103 by communication lines 121. Storage 111 is connected to processor 103 by communication lines 122. Bot builder service 10 is implemented and executed by the first branch of the parallel processing as described above. Personal Info Retrieval Manager 12 is implemented and executed by the second branch of the parallel processing as described above. Document Retrieval Module 13 is implemented and executed by the third branch of the parallel processing as described above. Tools Manager 11 is implemented and executed by the fourth branch of the parallel processing as described above. The first, second, third and fourth branches of FIG. 8 work in harmony to accomplish the parallel processing of the algorithm.

While the proposed invention of consolidating user-related information into a single, self-contained document offers numerous advantages, alternative methods, materials, or apparatuses could also be considered to address the same problems.

One alternative method is the use of a distributed database system. In this approach, user data could be stored across multiple nodes within a distributed database, such as Apache Cassandra. Each node would contain a portion of the data, and the system would use a distributed architecture to ensure data consistency and availability. While this method can enhance data redundancy and fault tolerance, it may still require complex synchronization mechanisms and might introduce latency due to the need for data retrieval across multiple nodes.

Another alternative is the use of a centralized API gateway that aggregates multiple APIs into a single entry point. This gateway would serve as an intermediary between the user-facing application and the various external data providers. It would handle all API calls, aggregate the responses, and return a unified data set to the application. Although this approach simplifies the integration process by providing a single interface, it still relies on multiple external APIs and can be prone to the same issues of API changes and potential downtimes.

Another potential alternative is the use of federated learning, where user data remains localized on individual devices, and only the aggregated learning updates are shared with a central server. This method enhances privacy by keeping raw data on the user's device, but it may not be suitable for all types of applications, particularly those requiring real-time data access and updates.

In conclusion, while the proposed invention of consolidating user-related information into a single document offers a robust solution to the identified problems, various alternatives exist. These include distributed databases, centralized API gateways, relational databases, edge computing, blockchain technology, and federated learning. Each alternative has its own set of advantages and limitations, and the choice of method, material, or apparatus would depend on the specific requirements and constraints of the application in question.

Direct API mapping could be another option. In this method, a static mapping system is implemented where each query is directly linked to a predefined function. This mapping is usually maintained in a lookup table or rule-based logic that determines the function to be called based on keywords or query parameters. While this approach can work in small-scale systems with a limited number of functions, it becomes impractical for large-scale implementations involving thousands of functions. It lacks the flexibility to adapt to dynamic user queries and cannot handle nuanced or complex intent detection. Updates to the system require significant manual effort. Manual API selection alternative on the other hand involves users or developers manually selecting the most appropriate function from a list based on their interpretation of the query. This could be done via a user interface or through direct interaction with the system's backend. This method is highly inefficient for automated systems or environments where real-time responses are critical. It is also prone to human error, which can lead to incorrect function execution and reduced overall system reliability.

I claim

1. A computer-implemented method for dynamically routing and processing user queries in a bot-builder system, the computer-implemented method comprising: receiving a user query at a bot-builder service; routing the user query to a Personal Info Retrieval Module, a Document Retrieval Module, and a Tool Manager; retrieving personal information from a Personal Info Store through the Personal Info Retrieval Module, wherein the Personal Info Retrieval Module updates the Personal Info Store in real time by invoking external services via API calls; retrieving document embeddings from a first vector store through the Document Retrieval Module; retrieving tool embeddings from a second vector store through the Tool Manager; processing the user query by an AI model to generate query embeddings; performing a similarity search using the query embeddings against the document embeddings in the first vector store to retrieve the most relevant document chunks; performing a similarity search using the query embeddings against the tool embeddings in the second vector store to retrieve the most relevant tools; combining the retrieved personal information, document chunks, and tools with the user query and chat history to form a comprehensive input; processing the comprehensive input by the AI model to determine an appropriate response pathway; generating a response based on the comprehensive input, delivering the final response to the user.

2. The method of claim 1, wherein the Personal Info Retrieval Module updates a Personal Info Store in real time by invoking external services via API calls.

3. The method of claim 2, wherein the document embeddings are generated by transforming textual data into high-dimensional vectors.

4. The method of claim 3, wherein the tool embeddings are generated by transforming tool descriptions, metadata, or usage examples into high-dimensional vectors.

5. The method of claim 4, wherein the response is either formulated using existing knowledge and personal information or involves invoking an external tool; if an external tool is required, generating the necessary API code through Tool Manager and executing API call through the bot builder; integrating the results from the external tool back into the system for further processing by the AI model; delivering the final response to the user.

6. The method of claim 1, wherein the response is either formulated using existing knowledge and personal information or involves invoking an external tool; if an external tool is required, generating the necessary API code through Tool Manager and executing API call through the bot builder; integrating the results from the external tool back into the system for further processing by the AI model.

7. The method of claim 1, wherein the Personal Info Retrieval Module retrieves personal data from external services selected from the group consisting of external services such as CRM platforms and HR systems.

8. The method of claim 1, wherein the document embeddings are generated by dividing original text documents into smaller chunks before transforming them into high-dimensional vectors.

9. The method of claim 4, wherein the tool embeddings are generated by transforming tool descriptions, metadata, or usage examples into high-dimensional vectors that align with the same vector space as document embeddings.

10. The method of claim 1, wherein the similarity search performed using the query embeddings against the document embeddings retrieves the top-K most relevant document chunks.

11. The method of claim 1, wherein the similarity search performed using the query embeddings against the tool embeddings retrieves the top-N most relevant tools.

12. The method of claim 1, further comprising updating the Personal Info Store directly by external services when there is a change or update in personal information.

13. The method of claim 1, wherein the AI model processes the comprehensive input to determine whether the response can be generated using existing knowledge and personal information or requires invoking an external tool.

14. The method of claim 1, wherein the Tool Manager transmits API documentation of external services to an AI model, which converts the specifications into a Tool Use format.

15. The method of claim 9, further comprising embedding the Tool Use JSON format into the vector store to enable seamless and efficient function handling.

16. The method of claim 1, wherein the AI model generates the client code required to call the selected tool or API, enabling seamless integration and execution.

17. The method of claim 1, further comprising dynamically updating the embeddings in the vector store in real time to ensure that responses reflect the most current data.

18. The method of claim 1, wherein the AI model integrates retrieved data, tools, and user context to deliver accurate, personalized responses.

19. The method of claim 1, further comprising leveraging historical interaction records extracted via post session flow and additional CRM data to generate more personalized and context-aware responses, wherein creating an individualized user document that contains comprehensive information about the user, including personal details such as birth dates, transaction histories, and post session conversation flow, customer preferences, behavioral patterns ; ensuring that user information is updated in real-time and accurately synchronized across systems; prompting a review process at the end of a session or interaction, therefore identifying any changes or additions to the user's personal information; identifying updates or modifications by analyzing the session data and comparing it with existing user profiles; and integrating the changes into the user's JSON profile during the post-session process.

20. The method of claim 1, wherein the bot-builder service manages API calls and the entire orchestration process from receiving and interpreting user queries to delivering contextually accurate and personalized responses.
